(19) United States
(12) Patent Application Publication
(10) Pub. No.: US 2006/0044502 A1
(43) Pub. Date: Mar. 2, 2006

(54) Liquid crystal display

(75) Inventor: Takashi Takagi, Tottori (JP)

Correspondence Address: GREER, BURNS & CRAIN, 300 S WACKER DR, 25TH FLOOR, CHICAGO, IL, 60606, US

(73) Assignee: SHARP KABUSHIKI KAISHA

(21) Appl. No.: 11/214,342

(22) Filed: Aug. 29, 2005

(30) Foreign Application Priority Data
Aug. 31, 2004 (JP) 2004-252242

(51) Int. Cl. G02F 1/1337

(52) U.S. Cl. 349/129

(57) ABSTRACT

The invention relates to a liquid crystal display filled with a liquid crystal by dispensing the liquid crystal onto a substrate, combining the substrate with an opposite substrate in vacuum with the surface of the substrate having the liquid crystal thereon facing the opposite substrate, and restoring the atmospheric pressure. The invention provides a liquid crystal display in which degradation of display quality due to an irregularity attributable to gravity can be suppressed. The liquid crystal display has a pair of substrates opposite to each other, a liquid crystal sealed between the substrates, a convex portion protruding into the liquid crystal from a surface of at least either of the pair of substrates and extending in a substantially horizontal direction when the pair of substrates is erected in the vertical direction, and a gap formed between the protruding end of the convex portion and a surface of the other substrate.

### BACKGROUND OF THE INVENTION

1. Field of the Invention

The present invention relates to a liquid crystal display that is filled with a liquid crystal by dispensing the liquid crystal on a substrate, combining the substrate with an opposite substrate in vacuum with the surface having the liquid crystal dispensed thereon facing the opposite substrate, and thereafter restoring the atmospheric pressure.

2. Description of the Related Art

There is increasing demand for liquid crystal displays, and display panels are being manufactured for various purposes, including small panels having a screen size on the order of a few inches and large panels having a screen size on the order of several tens inches to be used for televisions. Active matrix type color liquid crystal displays utilizing thin film transistors (TFTs) as switching elements are attracting attention as the main stream of flat panel displays, and there is strong demand for further improvements in the display quality of such displays.

FIG. 28 is a sectional view of a liquid crystal display 1001 taken in an upright position of the display in which a panel surface thereof extends in parallel with a vertical direction A1. As shown in FIG. 28, the liquid crystal display 1001 includes an array substrate 1002, an opposite substrate 1005 provided disposed opposite to the array substrate 1002, and a liquid crystal 1006 sealed between the array substrate 1002 and the opposite substrate 1005. Further, the liquid crystal display 1001 includes a seal material 1007 formed at peripheral parts of the array substrate 1002 and the opposite substrate 1005 and a plurality of pillar spacers 1003 provided so as to maintain the thickness (cell gap or cell thickness) of the liquid crystal 1006 between the substrates uniform in order to achieve preferable display without irregularities in luminance.

Steps for manufacturing the liquid crystal display 1001 are generally categorized into an array step for forming a wiring pattern on the array substrate 1002, a cell step including an aligning process, disposal of the pillar spacers 1003 and sealing of the liquid crystal 1006, and a module step for mounting driver Ics or the like. The one drop filling (ODF) method is used at the cell step as a technique for reducing the time required for the step.

According to the ODF method, the seal material 1007 is formed like a closed frame in advance at the periphery of the array substrate 1002. A predetermined amount of liquid crystal is dispensed from a liquid crystal dispenser which is not shown to a plurality of locations on a surface of the array substrate 1002 inside the frame formed by the seal material 1007. Next, the array substrate 1002 and the opposite substrate 1005 are combined in vacuum and are then returned to the atmosphere, and the liquid crystal 1006 is thereby dispersed between the array substrate 1002 and the opposite substrate 1005 thus combined.

The relationship between the height of the pillar spacers 1003 and the total amount of the liquid crystal dispensed has influence on a margin for processing according to the ODF method. The cell gap of a liquid crystal panel formed using the ODF method is substantially determined by the total amount of the liquid crystal 1006 dispensed except when the height of the pillar spacers 1003 is too large. Normally, the variation of the amount of the liquid crystal dispensed is normally ±1% or less, whereas the variation of the height of the pillar spacers 1003 is approximately in the range of ±3% to ±5% and is therefore greater than the variation of the amount of the liquid crystal dispensed, in general. When the height of the pillar spacers 1003 is too large relative to the total amount of the liquid crystal 1006 dispensed, bubbles (voids) are generated at low temperature. On the contrary, when the height of the pillar spacers 1003 is too small, the liquid crystal 1006 moves downward due to the weight of itself when the panel is vertically erected, in which case an irregularity attributable to gravity occurs in that the cell gap becomes undesirably great in a lower part of the panel. In either case, a display failure can occur. When the total amount of the liquid crystal 1006 dispensed and the height of the pillar spacers 1003 are in an adequate relationship with each other where the ODF method is employed, the pillar spacers 1003 are adequately compressed by the atmospheric pressure in the direction of the height thereof as shown in FIG. 28. Thus, a pressure is applied to the substrate, and a pressure acting on the liquid crystal 1006 is thereby reduced. Let us now assume that Ps represents the pressure acting on the pillar spacer 1003; Plc represents the pressure acting on the liquid crystal 1006; and the atmospheric pressure is 1 atm. Then, Plc=1−Ps (atm). Normally, the pressure Plc is smaller than 1 atm, and the pillar spacers 1003 are compressed to exert the pressure Ps on the substrate.

Since the atmospheric pressure is thus distributed to the pillar spacers 1003 and the liquid crystal 1006, the compressive force Plc acting on the liquid crystal 1006 can be smaller, the greater the compressive force distributed to the pillar spacers 1003. A pressure P1 acting on the liquid crystal 1006 can be thus suppressed to reduce the possibility of an irregularity attributable to gravity.

When the temperature of the panel increases to result in expansion of the volume of the liquid crystal 1006, an irregularity attributable to gravity can occur unless the pressure on the substrate exerted by the pillar spacers 1003 is maintained accordingly. This is another reason for the necessity of compressing the pillar spacers 1003 adequately at room temperature. Let us assume that the pillar spacers 1003 are not sufficiently compressed at room temperature because the height of the pillar spacers 1003 is too small with respect to the total amount of the liquid crystal 1006 dispensed as shown in FIG. 29. Then, a pressure P2 (>P1) acting on the liquid crystal 1006 is directed in the direction of gravity to generate a force that moves the liquid crystal 1006 in a vertical downward direction, and the liquid crystal 1006 is thereby moved downward to cause an irregularity attributable to gravity as shown in FIG. 30.

When the temperature of the panel increases, since the volume of the liquid crystal 1006 increases as a result of thermal expansion, a force acts in the direction of increasing the cell gap. The force cannot be dealt with the force of the pillar spacers 1003 urging the substrate when the normal compression of the pillar spacers 1003 is small, which results in an increase in a load P3 (>P2) acting on the liquid crystal 1006 and therefore results in an irregularity attributable to gravity as shown in FIG. 30. As a measure for preventing an irregularity attributable to gravity, the pillar spacers 1003 may be disposed in a lower density to increase the normal compressive displacement of the pillar spacers 1003. However, the measure must be taken after a close examination because there is possibility of a reduction in the withstand pressure of the panel. It is necessary to design the disposition density of the pillar spacers 1003 within a margin allowed for each of irregularities attributable to gravity and the withstand pressure of the panel which are in the relationship of tradeoff.

However, the mass of the liquid crystal 1006 increases with the size of the panel, and the margin allowed for irregularities attributable to gravity becomes small accordingly. Under the circumstance, it is becoming difficult to accommodate a great margin for a process using the ODF method.

Patent Document 1: JP-A-5-045661

### SUMMARY OF THE INVENTION

It is an object of the invention to provide a liquid crystal display in which degradation of display quality due to irregularities attributable to gravity can be suppressed.

The above-described object is achieved by a liquid crystal display characterized in that it includes a pair of substrate opposite to each other, a liquid crystal sealed between the pair of substrates, a convex portion protruding into the liquid crystal from a surface of at least either of the pair of substrates and extending substantially in the horizontal direction when the pair of substrates are erected in the vertical direction, and a gap formed between the protruding end of the convex portion and a surface of the other substrate.

According to the invention, the linear convex portion (rib) is formed in the panel in a direction that is orthogonal to the direction in which gravity acts on the panel when the panel is vertically erected. The rib is formed such that a gap of 2 μm or less is left between the rib and the opposite substrate. As a result, when the liquid crystal moves through the gap, a resistance acts against the movement, and the possibility of an irregularity attributable to gravity therefore becomes smaller than that in common liquid crystal displays. The possibility of an irregularity attributable to gravity can be small even when pillar spacers are formed with a small height with respect to the total amount of liquid crystal dispensed where the ODF method is employed. It is therefore possible to provide a great manufactural margin to accommodate some variation of the height of the pillar spacers. The rib does not result in any irregularity of the cell thickness because it does not contact the opposite substrate normally and have no influence on the disposition density of the pillar spacers. The invention makes it possible to provide a liquid crystal display in which degradation of display quality due to an irregularity attributable to gravity is suppressed.

### BRIEF DESCRIPTION OF THE DRAWINGS

FIG. 1 shows an example of a sectional configuration of a liquid crystal display according to a first embodiment of the invention;

FIG. 2 shows an example of a plan configuration of -the liquid crystal display according to the first embodiment of the invention;

FIG. 3 shows an example of a sectional configuration of a liquid crystal display according to a second embodiment of the invention;

FIG. 4 shows an example of a plan configuration of the liquid crystal display according to the second embodiment of the invention;

FIG. 5 shows an example of a plan configuration of an opposite substrate of the liquid crystal display according to the second embodiment of the invention;

FIG. 6 shows an example of a sectional configuration of the opposite substrate of the liquid crystal display according to the second embodiment of the invention;

FIG. 7 shows an example of a sectional configuration of the opposite substrate of the liquid crystal display according to the second embodiment of the invention;

FIG. 8 shows an example of a sectional configuration of the liquid crystal display according to the second embodiment of the invention;

FIG. 9 shows an example of a sectional configuration of the liquid crystal display according to the second embodiment of the invention;

FIG. 10 shows an example of a plan configuration of the opposite substrate of the liquid crystal display according to the second embodiment of the invention taken at a step of a method of manufacturing the same;

FIG. 11 shows an example of a plan configuration of the opposite substrate of the liquid crystal display according to the second embodiment of the invention;

FIG. 12 shows an example of a plan configuration of an array substrate of a liquid crystal display according to a third embodiment of the invention;

FIG. 13 shows an example of a plan configuration of an opposite substrate of the liquid crystal display according to the third embodiment of the invention;

FIG. 14 shows an example of a sectional configuration of a region, which has a rib formed therein, of the array substrate of the liquid crystal display according to the third embodiment of the invention;

FIG. 15 shows an example of a sectional configuration of the opposite substrate of the liquid crystal display according to the third embodiment of the invention;

FIG. 16 shows an example of a sectional configuration of a region, which has a pillar spacer formed therein, of the liquid crystal display according to the third embodiment of the invention;

FIG. 17 shows an example of a sectional configuration of a region, which has a rib formed therein, of the liquid crystal display according to the third embodiment of the invention;

FIG. 18 shows an example of a plan configuration of an array substrate of a liquid crystal display according to a fourth embodiment of the invention;

FIG. 19 shows an example of a sectional configuration of the array substrate of the liquid crystal display according to the fourth embodiment of the invention taken in a step for forming a pillar spacer region;

FIG. 20 shows an example of a sectional configuration of a region, which has a rib formed therein, of the array substrate of the liquid crystal display according to the fourth embodiment of the invention;

FIG. 21 shows an example of a sectional configuration of a region, which has a pillar spacer formed therein, of the array substrate of the liquid crystal display according to the fourth embodiment of the invention;

FIG. 22 shows an example of a sectional configuration of the liquid crystal display according to the fourth embodiment of the invention taken in a step for forming a pillar spacer region;

FIG. 23 shows an example of a sectional configuration of a region, which has a rib formed therein, of the liquid crystal display according to the fourth embodiment of the invention;

FIG. 24 shows an example of a sectional configuration of a region, which has a pillar spacer formed therein, of the liquid crystal display according to the fourth embodiment of the invention;

FIG. 25 shows an example of a plan configuration of an opposite substrate of a liquid crystal display according to a fifth embodiment of the invention;

FIG. 26 shows an example of a sectional configuration of a region, which has a pillar spacer formed therein, of the opposite substrate of the liquid crystal display according to the fifth embodiment of the invention;

FIG. 27 shows an example of a sectional configuration of a region, which has a rib formed therein, of the opposite substrate of the liquid crystal display according to the fifth embodiment of the invention;

FIG. 28 shows an example of a sectional configuration of a liquid crystal display according to the related art;

FIG. 29 shows an example of a sectional configuration of a liquid crystal display according to the related art; and

FIG. 30 shows an example of a sectional configuration of a liquid crystal display according to the related art.

### DESCRIPTION OF THE PREFERRED EMBODIMENTS

### First Embodiment

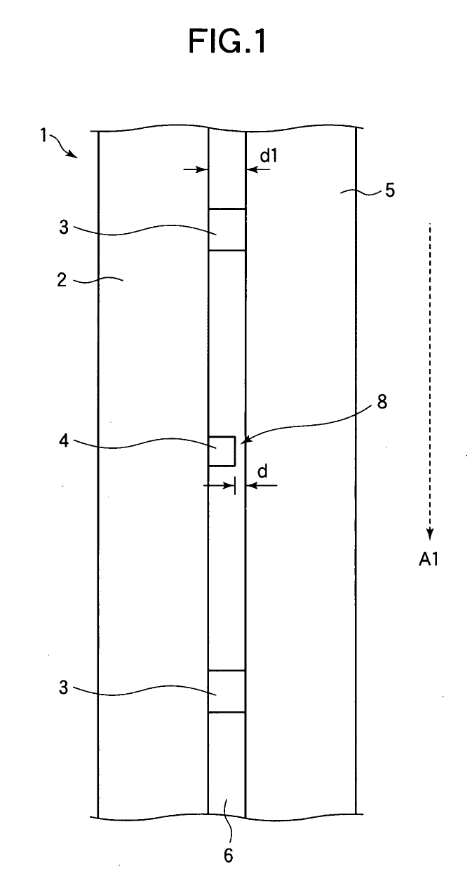

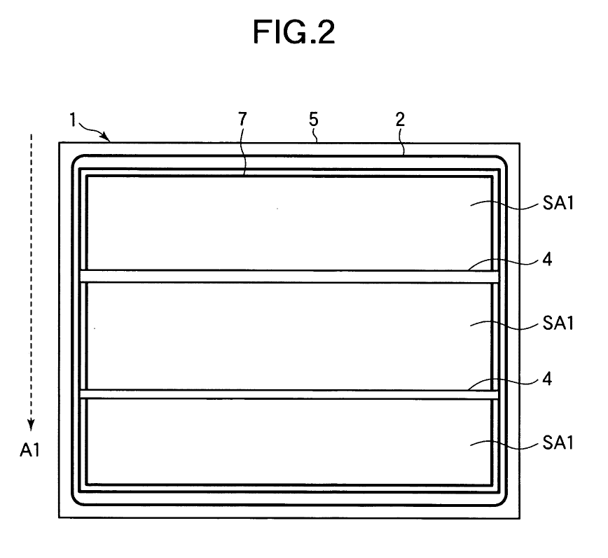

A liquid crystal display according to a first embodiment of the invention will now be described with reference to FIGS. 1 and 2. FIG. 1 shows a partial section of a panel of a liquid crystal display 1 according to the present embodiment in an upright position of the display in which panel surfaces are in parallel with a vertical direction A1. FIG. 2 is a view of the liquid crystal display 1 of the present embodiment taken in a direction toward the panel surfaces in the upright position of the display in which the panel surfaces are in parallel with the vertical direction A1. As shown in FIG. 1, the liquid crystal display 1 includes an opposite substrate 2 and an array substrate 5 disposed opposite to each other and a liquid crystal 6 sealed between the opposite substrate 2 and the array substrate 5. An opposite electrode and color filters (both of which are not shown) are formed on the opposite substrate 2. Gate bus lines, drain bus lines, TFT elements, pixel electrodes, storage capacitor electrodes, storage capacitor bus lines, and the like (none of which is shown) are formed on the array substrate 5. An image can be displayed in a desired manner by applying a voltage between the pixel electrodes and the opposite electrode to drive the liquid crystal 6.

A plurality of pillar spacers 3 is formed on the opposite substrate 2 in a predetermined pattern of disposition for maintaining a cell gap (having a gap width d1) between the array substrate 5 and the substrate 2. The pillar spacers 3 are formed of a photosensitive resin material such as an acrylic resin or novolac resin. The pillar spacers 3 can be elastically deformed in a predetermined amount in the direction of the height of the columns.

As shown in FIGS. 1 and 2, ribs 4 (convex portions) having a convex sectional shape are formed on a surface of the opposite substrate 2 such that they protrude into the liquid crystal 6 toward a surface of the array substrate 5. The ends of the ribs 4 are not in contact with the array substrate 5, and gaps 8 having a width d are formed between the ends of the ribs 4 and the surface of the array substrate 5. The ribs 4 are disposed so as to extend in the form of straight lines in the horizontal direction that is substantially orthogonal to the vertical direction A1 when the panel surfaces are in an upright position in parallel with the vertical direction A1. On the opposite substrate 2, a plurality of the ribs 4 are arranged in parallel with each other at predetermined intervals in the vertical direction A1. The ribs 4 are formed of a dielectric material and, in the present embodiment, the ribs are formed of the same resin material as the pillar spacers 3 in the same layer as the spacers 3 at the same time when the pillar spacers 3 are formed. As shown in FIG. 2, a seal material 7 for combining the opposite substrate 2 and the array substrate 5 and sealing the liquid crystal 6 therebetween is continuously formed throughout a peripheral region of the opposite substrate 2 outside a display area. Both ends of each rib 4 extend up to the seal material 7 into contact with the seal material 7. The liquid crystal 6 is divided into areas SA1 by the ribs 4.

Referring to the use of the ribs 4, when the liquid crystal display 1 is in an upright position in which the panel surfaces are in parallel with the vertical direction A1, the ribs 4 stop the liquid crystal 6 located above them to prevent the liquid crystal 6 from flowing in the vertical downward direction. The width d of the gaps 8 is determined in consideration to the weight of the liquid crystal 6 located above each rib 4, an internal pressure acting on the liquid crystal 6, and the characteristics of the liquid crystal 6 such as viscosity. The width d is adjusted to such a length that a resistance is generated to prevent the liquid crystal 6 from passing through the gaps 8 and moving downward and that the liquid crystal 6 is allowed to move between adjoining areas SA1 through the gaps 8 to be uniformly dispersed when the substrates 2 and 5 are combined after dispensing the liquid crystal using the ODF method. For example, in the case of a liquid crystal display with a display area having a diagonal dimension of 20 inches, irregularities attributable to gravity can be sufficiently eliminated when the width d of the gaps 8 substantially satisfies 0.2 μm≦d≦2 μm at room temperature. For example, the width d is preferably about 1 μm or less when the liquid crystal display 1 is vertically erected at a temperature as high as about 60° C.

### Second Embodiment

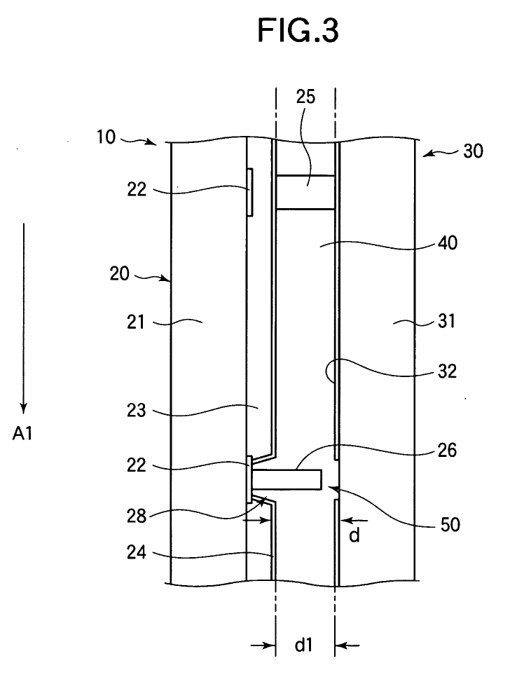

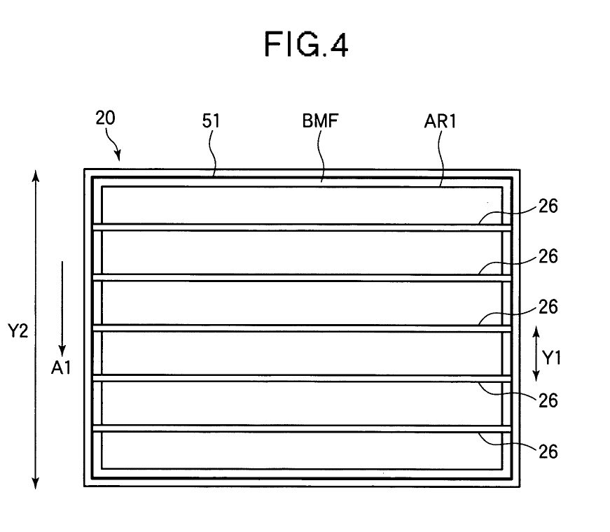

A liquid crystal display according to a second embodiment of the invention will now be described with reference to FIGS. 3 to 10. FIG. 3 shows a partial section of a panel of a liquid crystal display 1 according to the present embodiment in an upright position of the display in which panel surfaces are in parallel with a vertical direction A1. FIG. 4 is a view of the liquid crystal display 1 of the present embodiment taken in a direction toward the panel surfaces in the upright position of the display in which the panel surfaces are in parallel with the vertical direction A1. While the first embodiment has shown an example in which ribs 4 are formed on a surface of an opposite substrate 2 of a liquid crystal display 1, the present embodiment is characterized in that recesses 28 are provided on an opposite substrate 20 and in that ribs 26 are formed on the bottoms of the recesses 28.

A black matrix (BM; shielding film) 22 for defining pixel regions is formed of such as chromium (Cr) on a transparent substrate 21 which constitutes the opposite substrate 20. Color filter layers 23, which are color resin layers, are formed on the transparent substrate 21 and the black matrix 22. An opposite electrode 24 made of a transparent electrode material is formed on the color filter layers 23 throughout the opposite substrate 20.

In the region where the black matrix 22 is formed, pillar spacers 25 and ribs 26 are formed. The pillar spacers 25 are formed on the color filters 23 such that they protrude through the opposite electrode 24. The pillar spacers 25 are in contact with a surface 29 of an array substrate 30 and are compressed by the same, and the spacers maintain a predetermined cell gap d1.

The ribs 26 are formed in the recesses 28, which are dents on the surface of the opposite substrate 20 on the side thereof where the liquid crystal is located, provided by removing the color filter layers 23 on the black matrix 22. The ribs 26 are formed such that they protrude from the bottoms of the recesses 28. Gaps 50 are formed between the protruding end faces of the ribs 26 and the surface of the array substrate 30 on the side thereof where the liquid crystal is located.

While the ribs 4 in the first embodiment must be formed with a height smaller than that of the pillar spacers 3, the ribs 26 and the pillar spacers 25 of the present embodiment may be formed with substantially the same height. Since the ribs 26 are formed on the bottom of the recesses 28, the gaps 50 can be provided with a predetermined width d by setting the depth of the recesses 28 at a desired value.

As shown in FIG. 4, a seal material 51 is continuously formed throughout a peripheral part of the opposite substrate 20. The seal material 51 is formed outside a display area AR1. A black matrix film BMF which constitutes a picture-frame portion is formed like a frame in a region that is outside the display area AR1 and inside the seal material 51. In the region surrounded by the seal material 51, five ribs 26 are formed at intervals of Y1 in a vertical direction A1. The ribs 26 are formed in the horizontal direction that is orthogonal to the vertical direction A1. Both ends of the ribs 26 extend up to the black matrix film BMF provided around the display area and contact the seal material 51. For example, let us now assume that the opposite substrate 20 has a shorter length Y2 of about 300 mm. Then, there is an interval Y1 of 50 mm between each adjoining pair of the ribs 26, and there is the same interval of 50 mm between the parts of the seal material 51 at the upper and lower ends in the figure and the ribs 26 adjacent to the parts. The effect of preventing an irregularity attributable to gravity is more significant, the shorter the intervals Y1.

A description will now be made with reference to FIG. 5 on a more detailed plan configuration of the opposite substrate 20 having the ribs 26 formed thereon. FIG. 5 shows a detailed plan configuration of the opposite substrate 20. As shown in FIG. 5, the black matrix 22 of the opposite substrate 20 is formed to provide a light-shield for relevant regions of gate bus lines formed in the horizontal direction in the figure and relevant regions of drain bus lines formed in the vertical direction in the figure. Further, the black matrix 22 is patterned to serve as a light-shield for relevant regions of storage capacitor bus lines formed on the array substrate 30 so as to extend across respective pixel regions substantially in the middle thereof and relevant regions of TFT elements.

A color filter layer 23 (23R, 23G, or 23B) in any of red (R), green (G), and blue (B) is formed in each of the pixel regions. The R, G, and B color filter layers 23 are formed with substantially the same thickness. Linear protrusions 27 for alignment regulation are formed on the opposite electrode 24 which is formed on the color filter layers 23 throughout the substrate. The alignment regulating protrusions 27 are made of a dielectric material, and they have a function of regulating the alignment of the liquid crystal in a predetermined direction in cooperation with slits (not shown) formed on pixel electrodes 35 on the array substrate 30 side.

The pillar spacers 25 are formed in regions which are associated with the storage capacitor bus lines on the array substrate 30 side and in which the alignment regulating protrusions 27 are not formed. For example, one pillar spacer 25 is formed at a B pixel among six pixels in the form of a 2×3 matrix in FIG. 5. The pillar spacer 25 formed in one of the regions associated with the two storage capacitor bus lines which are adjacent to each other in the vertical direction in FIG. 5 is located in a position different from the position of the other pillar spacer 25 formed in the region associated with the other storage capacitor bus line when viewed in the vertical direction in the figure.

The ribs 26 are formed in regions associated with the gate bus lines such that they extend in the horizontal direction in the figure. The ribs 26 and the pillar spacers 25 are simultaneously formed from the same material at the same manufacturing process.

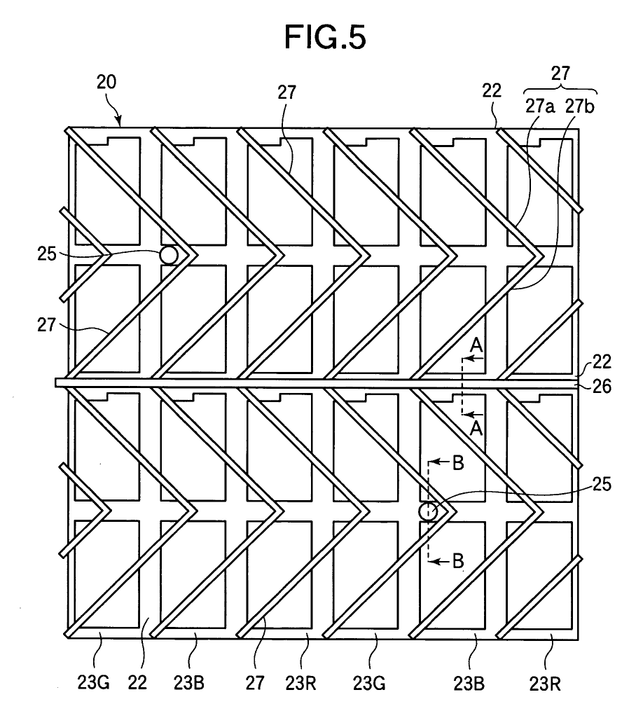

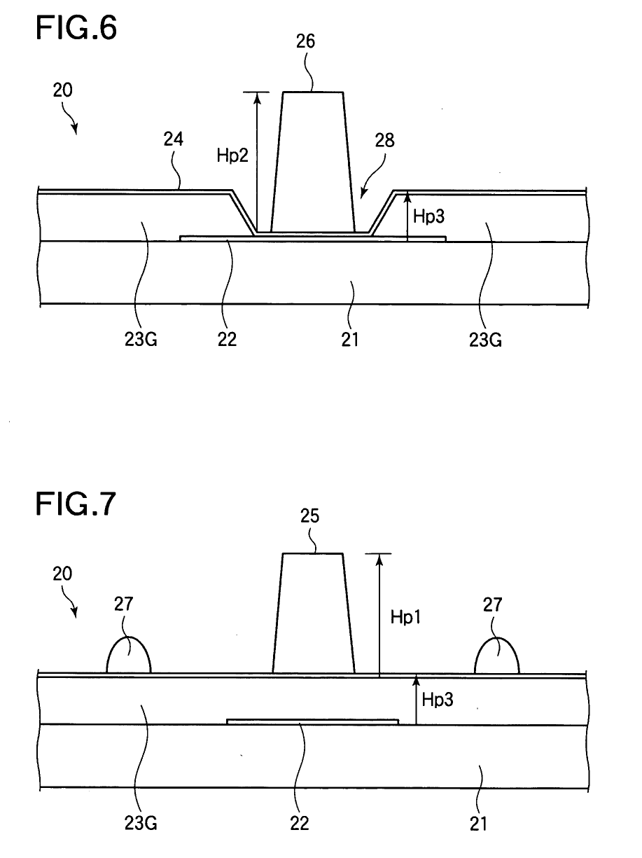

FIG. 6 shows a sectional configuration of the opposite substrate 20 taken along the line A-A in FIG. 5. As shown in FIG. 6, steps (having a height Hp3) are formed because of the recesses 28 in the regions of the opposite substrate 20 where the ribs 26 are formed. The ribs 26 protrude to a height Hp2 (>Hp3) above the opposite electrode 24 on the bottoms of the recesses 28 where the black matrix 22 and the opposite electrode 24 are formed on the transparent substrate 21, and the ribs are formed with a substantially trapezoidal sectional configuration.

FIG. 7 shows a sectional configuration of the opposite substrate 20 taken along the line B-B in FIG. 5. As shown in FIG. 7, the pillar spacers 25 protrude to a height Hp1 (which substantially equals the height Hp2) above the opposite substrate 24, and the spacers are formed with a substantially trapezoidal sectional configuration. The alignment regulating protrusions 27 are formed so as to protrude from the opposite electrode 24. FIGS. 6 and 7 show states of the elements before the opposite substrate 20 and the array substrate 30 are combined and the pillar spacers 25 are compressed in the direction of the height thereof. Therefore, there is a predetermined difference between the heights of the protruding end faces of the pillar spacers 25 and the ribs 26 formed on the opposite substrate 20.

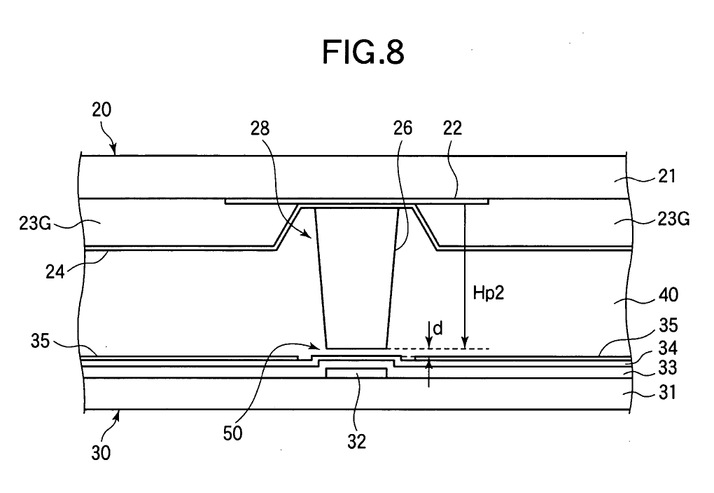

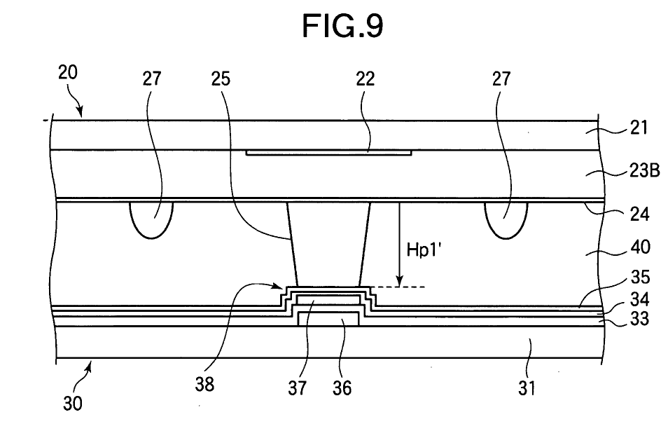

FIGS. 8 and 9 show states of the elements after the opposite substrate 20 and the array substrate 30 are combined. FIG. 8 shows a region where a rib is formed. FIG. 9 shows a region where a pillar spacer 25 is formed. The region of the array substrate 30 having a pillar spacer 25 formed therein shown in FIG. 9 has a sectional configuration as described below. In a storage capacitor portion 38 of the array substrate 30, a storage capacitor bus line 36 is formed on a transparent substrate 31. A storage capacitor electrode (intermediate electrode) 37 is formed on the storage capacitor bus line 36 such that it faces the storage capacitor bus line 36 with an insulation film 33 interposed therebetween. A pixel electrode 35 is formed on the storage capacitor electrode 37 with a protective film 34 interposed therebetween. The storage capacitor portion 38 is formed in a central part of the pixel region such that it extends to a height above the surface of the transparent substrate 31 in an open region surrounding the same.

In the vicinity of the storage capacitor portion 38 of the array substrate 3, the pixel electrode 35 is formed on the transparent substrate 31 with the insulation film 33 and the protective film 34 interposed therebetween. A pixel electrode 35 is formed in each pixel region. Although not shown, a pixel electrode 35 is formed with a plurality of slits (blanks in the electrode) extending diagonally with respect to edges of the pixel region. The slits serve as alignment regulating structures for regulating the alignment of the liquid crystal.

The pillar spacers 25 are formed in regions of the array substrate 30 associated with the storage capacitor bus lines 36. Referring to the region where a pillar spacer 25 is formed shown in FIG. 9, the pillar spacer 25 is compressed to a height Hp1′ (<Hp1) at which the spacer is in contact with the array substrate 30.

The region of the array substrate 30 having a rib formed therein shown in FIG. 8 has a sectional configuration as described below. A gate bus line 32 is formed on the transparent substrate 31. A gate insulation film 33 is formed on the transparent substrate 31 and the gate bus line 32. A protective film 34 is formed on the gate insulation film 33. The pixel electrode 35 is formed in a region on the protective film 34 where the gate bus line 32 is not located.

After the substrates are combined, in the region having a rib 26 formed therein shown in FIG. 8, the protruding end face of the rib 26 is not in contact with the array substrate 30, and a gap 50 is thus formed there. As thus described, a height difference in the color filter layer 23 is utilized to eliminate the need for adjusting the heights of the rib 26 and the pillar spacer 25 in order to form the gap 50.

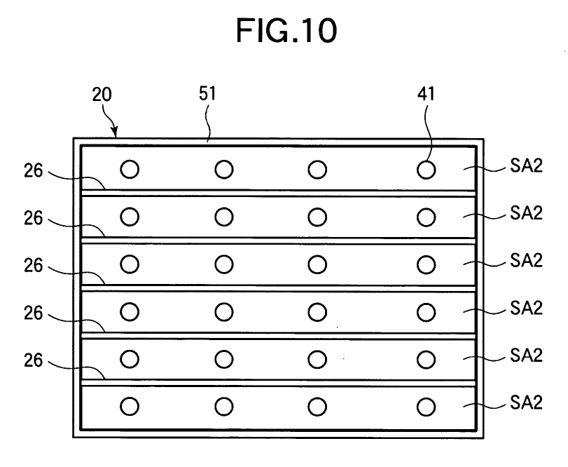

FIG. 10 shows a step for manufacturing a liquid crystal display 10 using the ODF method. More particularly, FIG. 10 shows how liquid crystal droplets are dispensed on an opposite substrate having ribs 26 formed thereon. In a region surrounded by a seal material 51 formed at the periphery of a transparent substrate 21, a plurality of ribs 26 (five ribs in the illustrated example) are arranged on the transparent substrate 21 to divide a dispensing area S into blocks (six blocks in the illustrated example). In each of resultant dispensing areas SA2, a plurality of liquid crystal droplets 41 are formed in the direction in which the rib 26 extends. When the liquid crystal droplets 41 are dispensed, one or a plurality of dispensers (not shown) is used to dispense the liquid crystal droplets at equal intervals in the dispensing area SA2.

The liquid crystal is dispensed a greater number of times, the greater the number of divisional dispensing areas SA2 as shown in FIG. 10. It is therefore preferable to set the number of the divisional dispensing areas SA2 in consideration to the tact of the manufacturing process according to the ODF method. In the present embodiment, the liquid crystal droplets 41 are dispensed in positions as shown in FIG. 10 in the form of a matrix of 6×4.

A method of manufacturing a liquid crystal display according to the present embodiment will now be described with reference to FIGS. 3 to 10. Primarily, steps for manufacturing a liquid crystal display include a substrate fabrication step, a liquid crystal dispensing (ODF) step, and a substrate combining step.

First, an opposite substrate 20 as shown in FIGS. 6 and 7 is fabricated as described below. A layer of a metal such as Cr is formed and patterned on a transparent substrate 21 made of glass having insulating properties to form a black matrix 22. Next, a resist including a pigment dispersed therein is applied and patterned to sequentially form colored layers which constitute color filter layers 23 (23R, 23G, and 23B). The thickness of the color filter layers 23 in each color is, for example, about 1.8 μm.

As shown in FIG. 6, in a region where a rib 26 is to be formed, a recess 28 is formed such that no color filter layer 23 will be left on the black matrix 22. As shown in FIG. 7, a color filter layer 23 is formed on the black matrix 22 in a region where a pillar spacer 25 is to be formed.

Next, as shown in FIG. 6, a transparent electrode 24 is formed on the color filter layer 23 and the black matrix 22 on the opposite substrate 20 in the region where a rib 26 is to be formed. For example, the transparent electrode 24 is formed of an ITO to a thickness of about 0.15 μm. As shown in FIG. 7, in a region where a pillar spacer 25 is to be formed, the transparent electrode 24 is formed on the color filter layer 23 of the opposite substrate 20.

Next, in a region where a pillar spacer 25 is to be formed, shown in FIG. 7, a dielectric layer is formed on the transparent electrode 24 to provide an alignment regulating protrusion 27 for regulating the alignment of a liquid crystal. At this time, the dielectric layer is preferably formed with a layout as shown in FIG. 5. For example, the dielectric layer is formed with a thickness of about 1.4 μm.

Next, pillar spacers 25 as shown in FIG. 7 and ribs 26 as shown in FIG. 6 are simultaneously formed. First, an acrylic resin type negative photosensitive resist is used to apply a resist film having a thickness of, for example, about 4.2 μm on to the transparent electrode 24 on the opposite substrate 20, and a pre-baking process is then performed at about 80° C. At this time, since there is a height difference of about 1.8 μm at a recess 28 having a rib 26 formed therein, there is a difference of about 0.8 μm between the protruding end faces of the pillar spacer 25 and the rib 26 by levelling the resist.

Next, the resist film is exposed and developed using a mask having a desired pattern, and baking is thereafter performed for about one hour in an oven at 220° C. to form the pillar spacer 25 and the rib 26. After the resist is baked, the protruding height Hp1 of the pillar spacer 25 is about 3.8 μm, and the rib 26 protrudes from the opposite electrode 24 above the color filter layer 23G to a height of about 3.2 μm. Thus, there is a difference of about 0.6 μm between the protruding end faces of the pillar spacer 25 and the rib 26.

An alignment film is formed on the opposite substrate 20 thus fabricated to complete the opposite substrate 20. For example, the completed opposite substrate 20 has a layout, for example, as shown in FIG. 5. In the present embodiment, as shown in FIG. 4, the ribs 26 are formed at intervals Y1 of about 50 mm.

Briefly, an array substrate 30 is fabricated as follows. In a storage capacitor portion 38 of the array substrate 30, as shown in FIG. 9, a storage capacitor bus line 36 is formed on a transparent substrate 31. A storage capacitor electrode 37 is formed above the storage capacitor bus line 36 so as to face the storage capacitor bus line 36 with an insulation film 33 interposed therebetween, and a pixel electrode 35 is formed above the storage capacitor electrode 37 with a protective film 34 interposed therebetween.

In a region of the array substrate 30 where a gate bus line 32 is to be formed, as shown in FIG. 8, the gate bus line 32 is formed on the transparent substrate 31. A protective film 35 is formed above the transparent substrate 31 and the gate bus line 32 with a gate insulation film 38 interposed therebetween. The pixel electrode 35 is formed in a region on the protective film 34 where the gate bus line 32 is not located. An alignment film is then formed on the surface of the substrate to complete the array substrate 30.

A liquid crystal is then dispensed on the opposite substrate 20 having the ribs 26 formed thereon. The liquid crystal is dispensed in each of the areas divided by the ribs 26. Specifically, as shown in FIG. 10, when liquid crystal droplets 41 are dispensed, one or a plurality of dispensers (not shown) is used to dispense the liquid crystal droplet at equal intervals in dispensing areas SA2. For example, one droplet is dispensed onto one dispensing area SA2, and the dispenser is then horizontally moved to the right or left in the figure (the direction in which the ribs 26 extend) to dispense the next droplet. Thus, liquid crystal droplets are sequentially dispensed at equal intervals to the right or left one at a time. The droplets are dispensed in the same amount. When droplets have been dispensed on the dispensing area SA2 at equal intervals to the right or left, droplets are sequentially dispensed onto the next dispensing area SA2. At this time, the liquid crystal droplets 41 are dispensed such that the intervals between the liquid crystal droplets 41 dispensed onto one of the adjoining dispensing areas SA2 equal the intervals between the liquid crystal droplets 41 dispensed onto the other dispensing area SA2. When a plurality of dispensers is used, the liquid crystal may be simultaneously dispensed onto the dispensing areas SA2.

The opposite substrate 20 having liquid crystal droplets thus dispensed thereon is combined with the array substrate 30 in vacuum and is thereafter put back in the atmosphere. When the substrates are combined, as shown in FIG. 8, the substrates are disposed such that the ribs 26 on the opposite substrate 20 face the regions on the array substrate 30 wherein the gate bus lines 32 are formed. At the same time, the substrates are disposed such that the pillar spacer 25 on the opposite substrate 20 face the storage capacitor portion 28 on the array substrate 30. When the combined substrates are put back in the atmosphere, the panel surfaces are urged by the atmospheric pressure to spread the liquid crystal droplets 41. Liquid crystal 40 flows through gaps 50 to spread. A seal material 51 is cured while the liquid crystal 40 is spreading. The liquid crystal display 10 is then heated to fluidize the liquid crystal 40, thereby spreading the liquid crystal 40 uniformly in the cell gap. The liquid crystal 40 flows through the gaps 50 when the liquid crystal is fluidized.

In the liquid crystal display 10, the liquid crystal is normally at an internal pressure lower than the atmospheric pressure. As shown in FIG. 9, the pillar spacers 25 are compressed by an amount in the range from about 0.1 μm to about 0.4 μm. The amount of compression depends on the density and size in which the pillar spacers 25 are formed.

The ribs 26 are formed such that they protrude to a height which is about 0.6 μm lower than the protruding height of the pillar spacers 25. As a result, when the substrates are combined, the protruding end faces of the ribs 26 do not contact the array substrate 30, and gaps 50 with a width d in the range from about 0.2 μm to about 0.5 μm are formed between the end faces and the array substrate 30, as shown in FIG. 8.

As thus described, in the present embodiment, even when the protruding height Hp2 of the ribs 26 is set substantially equal to or greater than the protruding height Hp1 of the pillar spacers (before compression), the width d of the gaps 50 can be obtained to prevent irregularities attributable to gravity by setting the depth of the recesses 28 (the thickness of the color filter layers 23) at a desired value. It is therefore possible to form the ribs and the pillar spacers simultaneously at the same step using the same material.

The gaps 50 formed by the ribs 26 are, for example, about 1 μm or less even when the liquid crystal display 10 is erected in parallel with the vertical direction A1 and put in a temperature as high as about 60° C. Therefore, irregularities attributable to gravity can be sufficiently suppressed when compared to those in liquid crystal displays in the related art without the ribs 26.

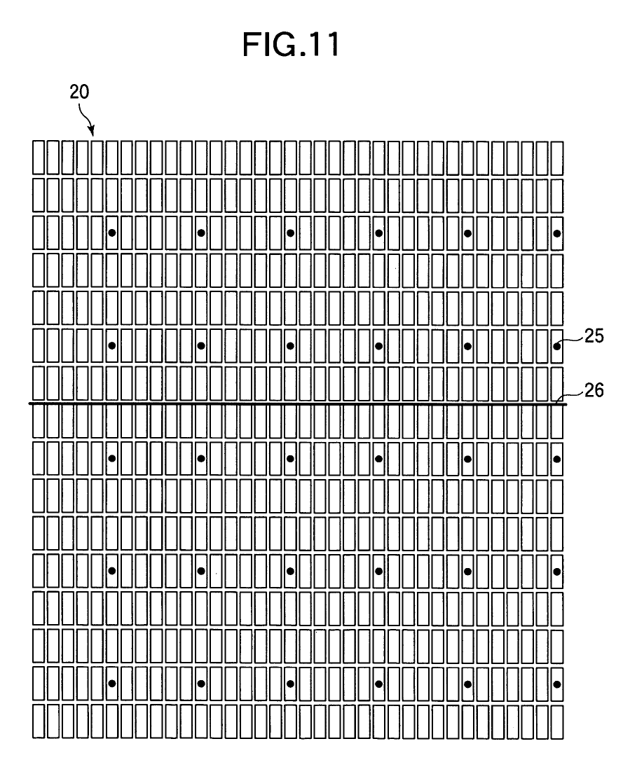

FIG. 11 shows a part of a surface of the opposite substrate 20 thus completed by way of example. In this example, pillar spacers 25 are formed at a rate of one per six pixels in the horizontal direction and at a rate of one per three pixels in the vertical direction. The positions of the pillar spacers 25 are in regions which are associated with storage capacitor bus lines on the array substrate side. Thus, the pillar spacers 25 are disposed at predetermined intervals in the form of a matrix.

A rib 26 is formed to extend in a region which is associated with a gate bus line on the array substrate side. The rib 26 is located between upper and lower groups of the pillar spacers 25 as shown in the figure. The rib is spaced from one of the groups of the pillar spacers 25 by one pixel or more and is also spaced from the other group of the pillar spacers 25 by one pixel or more. In the present embodiment, there is an interval of at least nine pixels between ribs 26 which are adjacent to each other.

### Third Embodiment

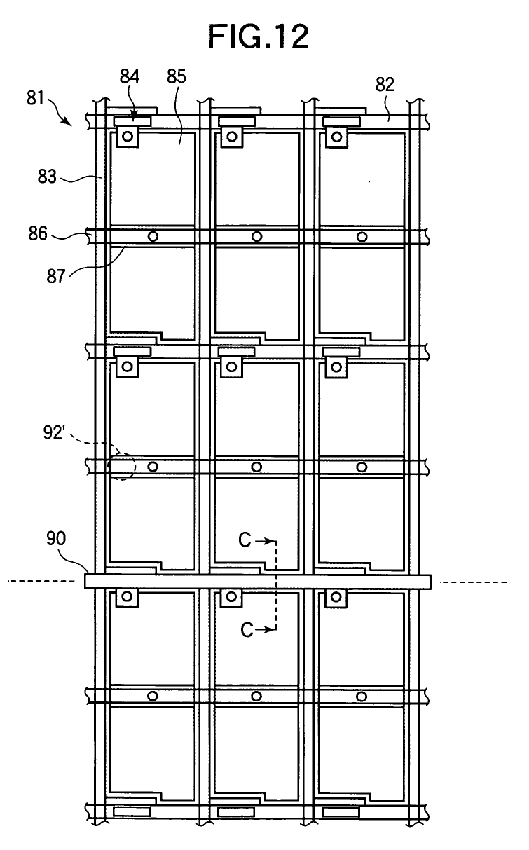

A third embodiment of the invention will now be described with reference to FIGS. 12 to 17. FIG. 12 is a plan view of a liquid crystal display according to the present embodiment. While the first and the second embodiments have shown examples in which ribs 4 and 26 are formed on opposite substrates 2 of liquid crystal displays 1, respectively, the present embodiment will show an example in which ribs 90 are formed on an array substrate 81.

FIG. 12 shows a configuration of nine pixels on an array substrate 81 of a liquid crystal display. Specifically, as shown in FIG. 12, the array substrate 81 of the liquid crystal display has a plurality of gate bus lines 82 extending in the horizontal direction in FIG. 12 and a plurality of drain bus lines 83 extending in the vertical direction in FIG. 12 across the gate bus lines 82 with an insulation film interposed therebetween, the bus lines being provided on a transparent substrate.

TFT elements 84 are formed in the vicinity of positions where the gate bus lines 82 and the drain bus lines 83 intersect. Pixel regions are defined by the gate bus lines 82 and the drain bus lines 83. A storage capacitor bus line 86 extending in parallel with the gate bus lines 82 is formed across each of the pixel regions. The storage capacitor bus line 86 serves as one electrode of a storage capacitor portion. A storage capacitor electrode 87 is formed above the storage capacitor bus line 86 with an insulation film interposed therebetween. A storage capacitor electrode 87 is formed at each of the pixel regions, and serves as another electrode of the storage capacitor portion. A protective film is formed on the storage capacitor electrodes 87 throughout the substrate. A pixel electrode 85 is formed on the protective film at each of the pixel regions. Ribs 90 are formed in regions which overlap the gate bus lines 82.

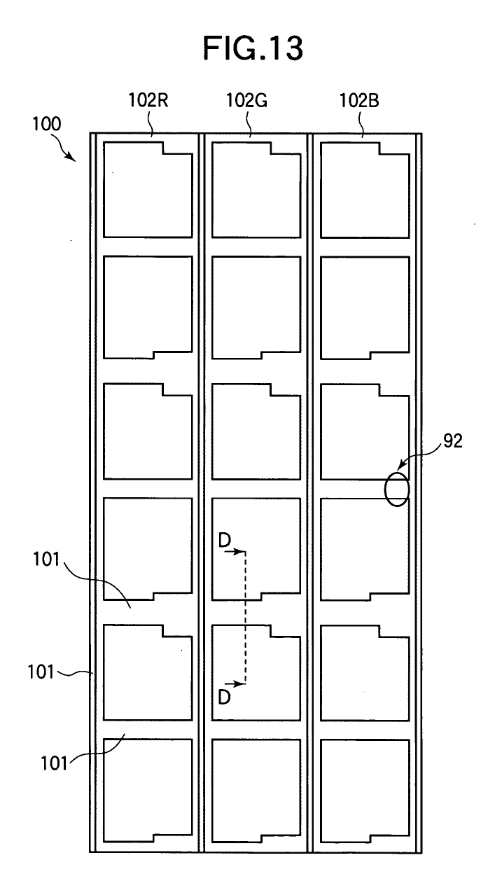

As shown in FIG. 13, an opposite substrate 100 has a black matrix 101 formed in regions to be shielded from light which are associated with the periphery of the pixel regions and the storage capacitor bus lines 86, and red, green, and blue color filter layers 102 (102R, 102G, and 102B) constituted by resin layers are also formed on the substrate. The black matrix 101 is formed in regions which cover the pixel electrodes 85 disposed in the form of a matrix, the gate bus lines 82, the drain bus lines 83, the storage capacitor bus lines 86, the storage capacitor electrodes 87, and the TFT elements 84 after the substrates are combined. Thus, those regions are shielded from light. Therefore, the ribs 90 are disposed in positions in which they face the black matrix 101 formed on a surface of the opposite substrate 100 after the substrates are combined.

Pillar spacers 92 are formed on the color filter layers 102 in regions of the opposite substrate 100 which overlap the storage capacitor bus lines 86 when the array substrate 81 is disposed opposite to the substrate 100 (e.g., the region indicated by reference numeral 92′ in FIG. 12). While the example in FIG. 12 represents a case in which the pillar spacers 92 are formed on the opposite substrate 100, this is not limiting the invention, and the spacers may be formed on the array substrate 81. The pillar spacers 92 are disposed in regions of the opposite substrate 100 which are shielded from light and which are associated with the storage capacitor portions. After the substrates are combined, protruding end faces of the pillar spacers 92 are substantially entirely in contact with the storage capacitor portions.

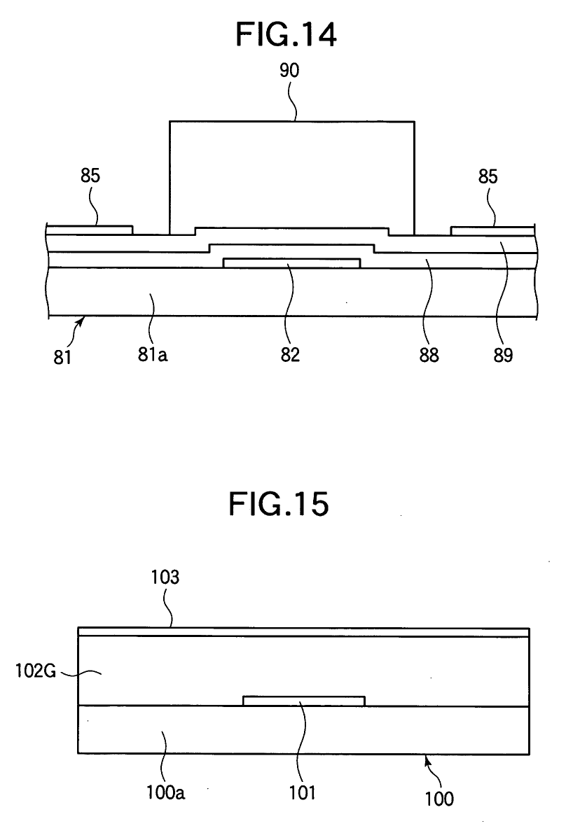

FIG. 14 shows a sectional configuration of the array substrate of the liquid crystal display taken along the line C-C in FIG. 12. The sectional configuration of the array substrate 81 shown in FIG. 14 is as described below. A gate bus line 82 is formed on a transparent substrate 81a. A gate insulation film 88 is formed on the transparent substrate 81a and the gate bus line 82. A protective film 89 is formed on the gate insulation film 88. A rib 90 is formed on the protective film 89 in a position associated with the gate bus line 82. A pixel electrode 85 is formed in a region on the protective film 89 where the gate bus line 82 is not located.

FIG. 15 shows a sectional configuration of the opposite substrate of the liquid crystal display taken along the line D-D in FIG. 13. The sectional configuration of the opposite substrate 100 shown in FIG. 15 is as described below. The black matrix 101 is formed on a transparent substrate 100a. A color filter layer 102 is formed on the black matrix 101 (a G color filter layer 102G in the illustrated example). An opposite electrode 103 is formed on the color filter layer 102.

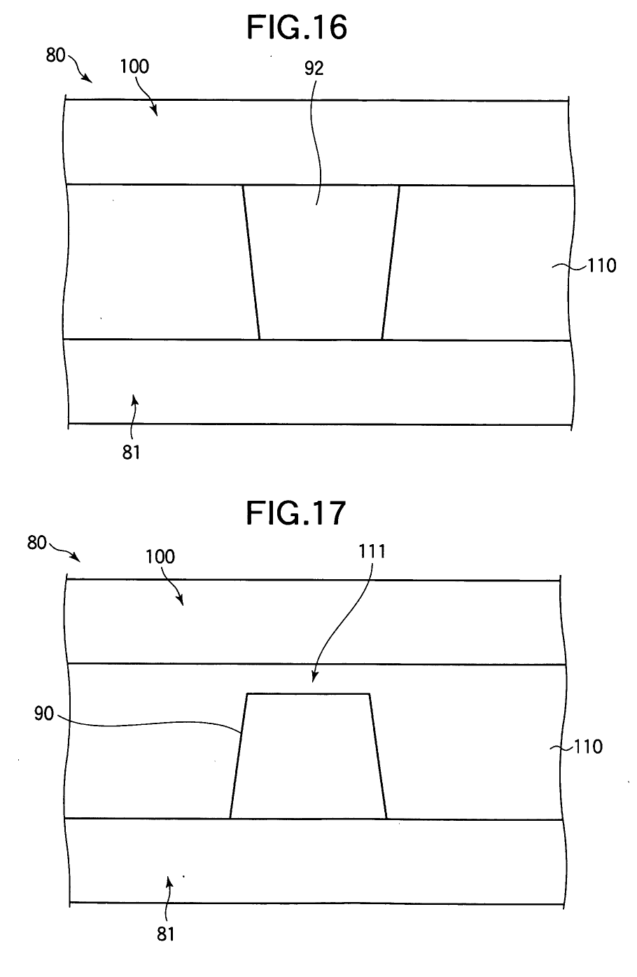

When such an opposite substrate 100 and array substrate 81 are combined, a liquid crystal display 80 having sectional configurations as shown in FIGS. 16 and 17 is provided. In the region of the liquid crystal display 80 shown in FIG. 16, a pillar spacer 92 is formed in a compressed state in a liquid crystal 110 sealed between the array substrate 81 and the opposite substrate 100.

In the region of the liquid crystal display 80 shown in FIG. 17, a rib 90 is formed in the liquid crystal 110 sealed between the array substrate 81 and the opposite substrate 100 with a predetermined gap 111 maintained between the rib 90 and the opposite substrate 100.

A method of manufacturing an array substrate 81 of a liquid crystal display 80 having the above-described configuration will be described with reference to FIGS. 12 to 14. As shown in FIGS. 12 to 14, gate bus lines 82 and drain bus lines 83 are formed like a matrix. A pixel electrode 85 and a TFT element 84 for driving the pixel electrode 85 are formed at an intersection between a gate bus line 82 and a drain bus line 83. A source electrode of the TFT element 84 and the pixel electrode 85 are in conduction to each other through a contact hole (not shown) formed in a protective film 89 made of such as SiN.

Ribs 90 as shown in FIG. 12 are formed in a desired pattern on the array substrate 81 using a negative resist. For example, the thickness of the ribs 90 is about 3.0 μm. Pillar spacers 92 having a thickness of, for example, about 4.2 μm are formed on an opposite substrate 100. A liquid crystal is dispensed on such an array substrate 81 using the ODF method or the like, and the array substrate 81 and the opposite substrate 100 are combined to form a liquid crystal display 1.

As thus described, in the present embodiment, the pillar spacers 92 are formed on the opposite substrate 100 side, and the ribs 90 are formed on the array substrate 81 side. It is therefore possible to form the ribs 90 and the pillar spacers 92 using separate manufacturing processes. Thus, the ribs 90 can be independently formed to a height different from that of the pillar spacers 92 from a material different from that of the spacers.

The pillar spacers 92 formed on the opposite substrate 100 are compressed by, for example, about 0.2 μm, and there are gaps 111 as small as about 1 μm between the ribs 90 and the opposite substrate 100 at this time. Since this results in a large resistance to a movement of the liquid crystal through the gaps 111, the possibility of an irregularity attributable to gravity can be reduced.

### Fourth Embodiment

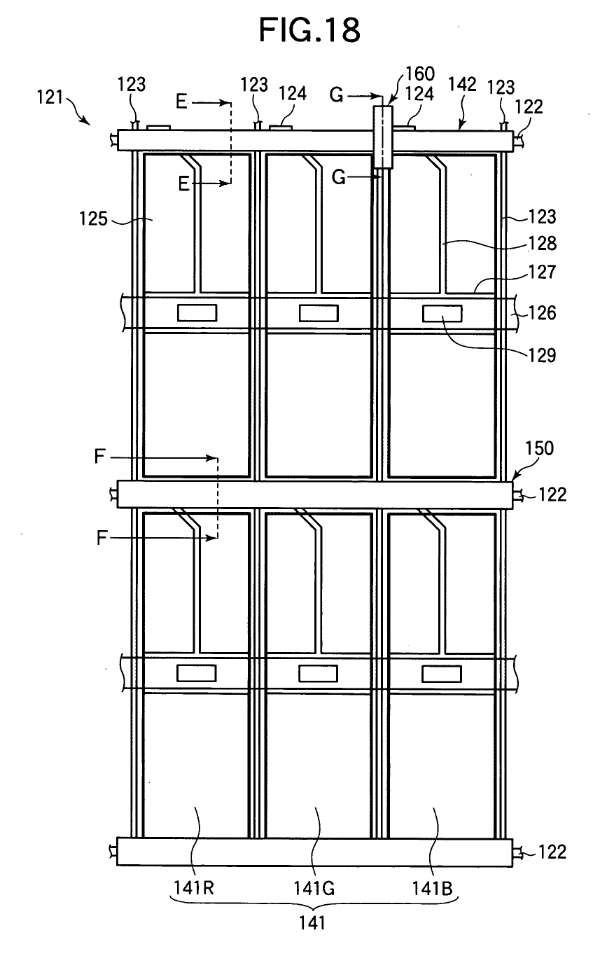

A fourth embodiment of the invention will now be described with reference to FIGS. 18 to 24. FIG. 18 shows an example of a plan configuration of a liquid crystal display according to the present embodiment. The third embodiment has shown an example in which ribs 90 are formed on an array substrate 81 side of a liquid crystal display and in which color filter layers 102 are formed on an opposite substrate 100 side. The present embodiment will show an example in which color filter layers 141 and ribs 150 are formed on an array substrate 121 side.

Specifically, the array substrate 121 of the liquid crystal display of the present embodiment has a CF-on-TFT (COT) structure as shown in the plan configuration in FIG. 18. As shown in FIG. 18, the array substrate 121 includes gate bus lines 122, drain bus lines 123, TFT elements 124, pixel electrodes 125, storage capacitor bus lines 126, storage capacitor electrodes 127, and connection wirings 128. The array substrate 121 further includes color filter layers 141 (141R, 141G, and 141B), layered resin portions 142, ribs 150, and pillar spacers 160.

A plurality of the gate bus lines 122 is formed so as to extend in the horizontal direction in the figure. The drain bus line 123 is formed above the gate bus lines 122 with an insulation film (gate insulation film) interposed therebetween. A plurality of the drain bus lines 123 is formed so as to extend in the vertical direction in the figure across the gate bus lines 122. Pixel regions are defined by the gate bus lines 122 and the drain bus lines 123.

The TFT elements 124 are formed in the vicinity of positions where the gate bus lines 122 and the drain bus lines 123 intersect each other. Drain electrodes of the TFT elements 124 are electrically connected to the drain bus lines 123. Gate electrodes of the TFT elements 124 are electrically connected to the gate bus lines 122. A protective film is formed on the TFT elements 124 throughout the substrate.

A storage capacitor bus line 126 extends in parallel with the gate bus lines 122 across each of the pixel regions. The storage capacitor bus line 126 serves as one electrode of a storage capacitor portion.

Storage capacitor electrodes 127 are formed above the storage capacitor bus lines 126 with an insulation film interposed therebetween. A storage capacitor electrode 127 is formed at each of the pixel regions to serve as another electrode of the storage capacitor portion. The storage capacitor electrodes 127 are electrically connected to source electrodes of the TFT elements 124 through the connection wirings 128.

The color filter layers 141 (141R, 141G, and 141B) are formed at each of the pixel regions on the protective film. Each of the color filter layers 141 at each pixel region is in any of red, green, and blue.

A layered resin portion 142 is formed above and along a gate bus line 122 having a pillar spacer 160 formed thereon. The layered resin portion 142 is preferably constituted by two layers stacked one over another, i.e., a first colored layer formed by extending a color filter layer 141 in any of red, green, and blue at the pixel region and a second colored layer formed by extending another color filter layer 141 in a color different from the first colored layer at the pixel region. The layered resin portion 142 has a width greater than the width of the gate bus line 122.

The layered resin portions 142 serve as a (horizontally extending) part of a black matrix for shielding the gate bus lines 122 and the TFT elements 124 from light. When the layered resin portions 142 are also formed at the boundaries between the color filter layers of the horizontal arrays of pixel regions in the figure (or when the portions 142 are formed in the direction in which the drain bus lines extend), since light can be blocked in the vertical direction as well as the horizontal direction, no black matrix is required on the opposite substrate side.

A pixel electrode 125 is formed at each of the pixel regions on the color filter layers 141. The pixel electrode 125 is electrically connected to the storage capacitor electrode 127 through openings 129 provided in the color filter layers 141 and the protective film.

The pillar spacers 160 are formed on the layered resin portions 142 in a disposition density of one per several pixels to several tens pixels. The pillar spacers 160 linearly extend substantially orthogonally to the layered resin portions 142, and the spacers are formed so as to overlap a part of the drain bus lines 122. A pillar spacer 160 has a substantially constant width which extends for example 10 μm from both side edges of a layered resin portion 142. Top surfaces of the pillar spacers 160 contact the surface of the opposite substrate when the substrate is combined with the opposite substrate disposed in a face-to-face relationship.

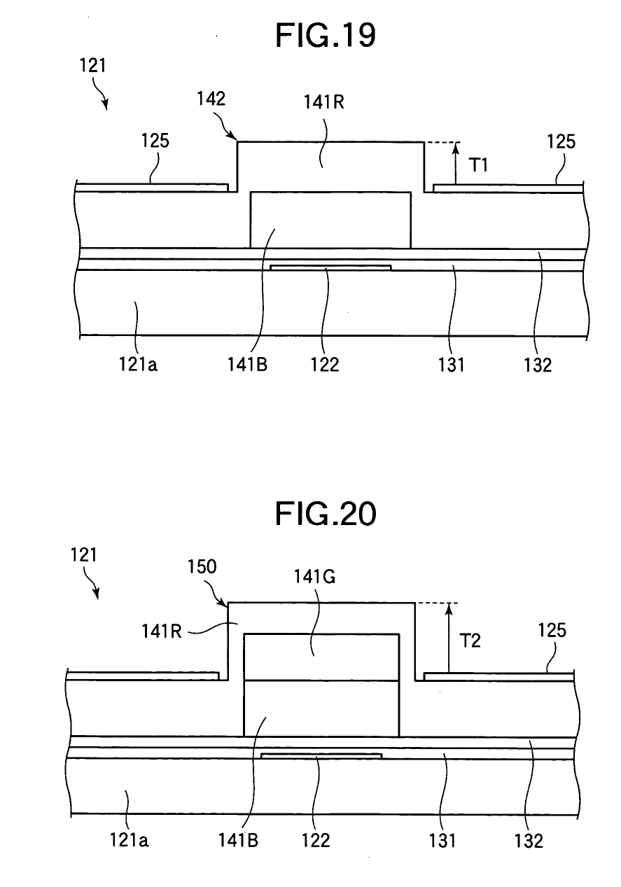

The ribs 150 are formed on gate bus lines 122 having no layered resin portion 142 formed thereon. A rib 150 has a three-layer structure which is a stack of first through third colored layers formed by extending the respective color filter layers 141 in three colors, i.e., red, green, and blue at each pixel region. While the layered resin portion 142 of a pillar spacer 160 is obtained by stacking the color filter layers 141B and 141R in two colors as shown in FIG. 19, the rib 150 is obtained by stacking three color filter layers 141B, 141G, and 141R as shown in FIG. 20.

FIG. 19 shows a sectional configuration taken along the line E-E in FIG. 18. A gate bus line 122 is formed on a transparent substrate in the region of the array substrate 121 where a pillar spacer is formed. A gate insulation film 131 is formed on the gate bus line 122. A protective film 132 is formed on the gate insulation film 131.

A B (blue) color filter layer 141B is formed on the protective film 132 in the region where the gate bus line 122 is formed. In the single pixel region, an R (red) color filter layer 141R is formed on the protective film 132 in the region where the gate bus line 122 is not formed. In the region where the gate bus line 122 is formed, the R (red) color filter layer 141R is formed on the B (blue) color filter layer 141B.

A layered resin portion 142 is formed by forming the color filter layer 141R on the color filter layer 141B. A pixel electrode 125 is formed on the color filter layer 141R except the region of the layered resin portion 142. The layered resin portion 142 protrudes to a height T1 which is equal to the thickness of the color filter layer 141R. The layered resin portion 142 has a shielding function because it has a two-layer structure constituted by the color filter layers 141R and 141B.

FIG. 20 shows a sectional configuration taken along the line F-F in FIG. 18. The sectional configuration of the rib 150 is formed by stacking color filter layers 141 in three colors. A gate bus line 122 is formed on the transparent substrate in the region of the array substrate 121 where the rib 150 is formed. A gate insulation film 131 is formed on the gate bus line 122. The protective film 132 is formed on the gate insulation film 131.

A B (blue) color filter layer 141B is formed on the protective film 132 in the region where the gate bus line 122 is formed. A G (green) color filter layer 141G is formed on the color filter layer 141B. In the single pixel region, an R (red) color filter layer 141R is formed on the protective film 132 in the region where the gate bus line 122 is not formed. In the region where the gate bus line 122 is formed, the R (red) color filter layer 141R is formed on the color filter layer 141G.

A rib 150 is formed by forming the color filter layer 141G on the color filter layer 141B and forming the color filter layer 141R on the color filter layer 141G. A pixel electrode 125 is formed on the color filter layer 141R except the region of the rib 150. The rib 150 protrudes to a height T2 which is equal to the combined thickness of the color filter layer 141G and the color filter layer 141R. In the three-layer structure of the rib 150, the color filter layers 141B, 141G, and 141R have respective thicknesses which become smaller in the order in which the layers are listed.

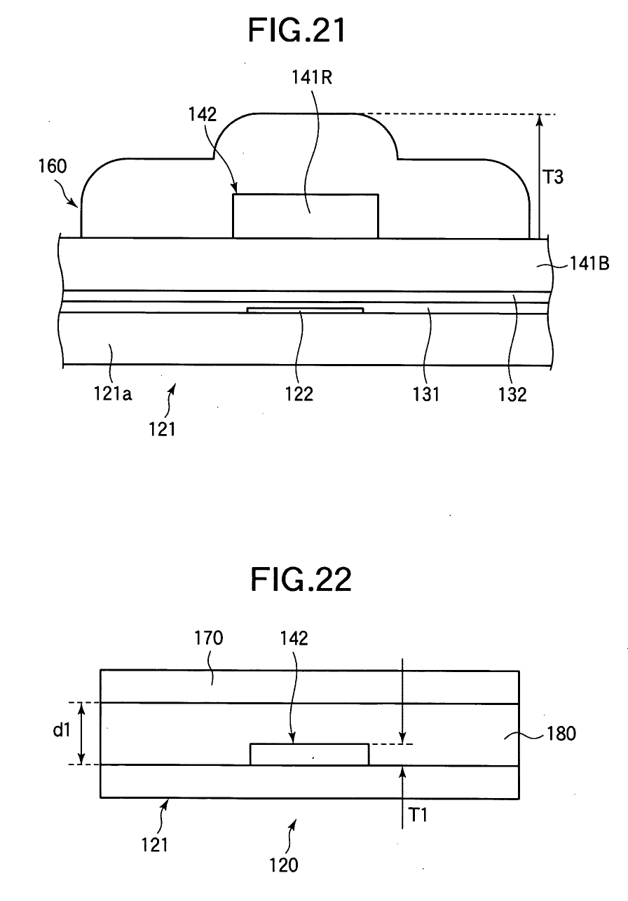

FIG. 21 shows a sectional configuration taken along the line G-G in FIG. 18. FIG. 21 shows an idealistic pattern of the pillar spacer 160. In the region of the array substrate 121 where the pillar spacer 160 is formed, a gate bus line 122 is formed on a transparent substrate. A gate insulation film 131 is formed on the gate bus line 122. The protective film 132 is formed on the gate insulation film 131.

A B (blue) color filter layer 141B is formed on the protective film 132. In the single pixel region, an R (red) color filter layer 141R is formed on the protective film 132 in the region where the gate bus line 122 is formed. In the region where the gate bus line 122 is formed, the R (red) color filter layer 141R is formed on the color filter layer 141B. A layered resin portion 142 is formed by forming the color filter layer 141R on the color filter layer 141B.

A pillar spacer 160 is formed by forming a resist layer on the layered resin portion 142 and the color filter layer 141B. The pillar spacer 160 protrudes to a height T3 which is equal to the combined thickness of the color filter layer 141R and the resist layer.

FIGS. 22 to 24 are illustrations for a comparison between the protruding heights of a layered resin portion, a rib, and a pillar spacer after the substrates are combined. FIG. 22 shows a sectional configuration of a region of a liquid crystal display 120 where a layered resin portion 142 is formed. The liquid crystal display 120 has an array substrate 121, an opposite substrate 170, and a liquid crystal 180 sealed between the array substrate 121 and the opposite substrate 170. The array substrate 121 has layered resin portions 142 which protrude from the substrate surface into the liquid crystal 180. The regions of the liquid crystal display 120 having the layered resin portions 142 formed therein protrude to a height T1 above the substrate surface. The layered resin portions 141 in which colors are thus overlapped serve as a light-shield portion (black matrix) for shielding regions along gate bus lines from light.

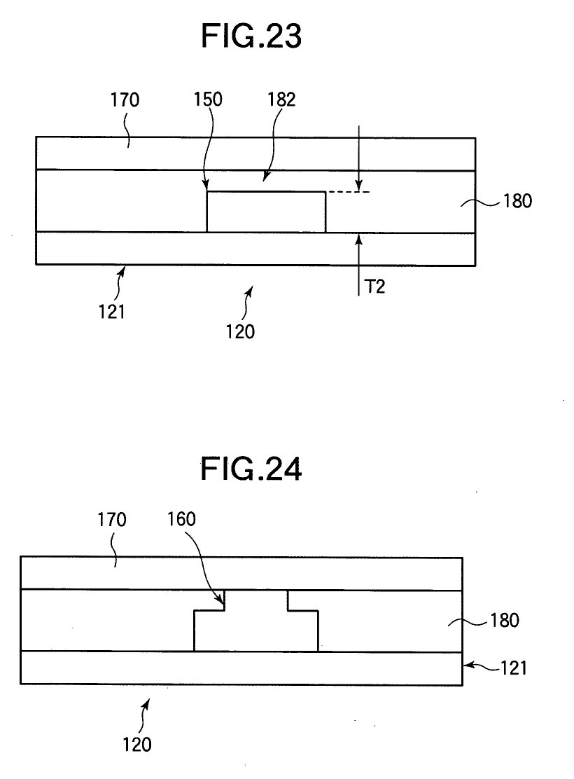

FIG. 23 shows a sectional configuration of a region of the liquid crystal display 120 where a rib 150 is formed. The array substrate 121 has ribs 150 which protrude from the substrate surface into the liquid crystal 180. The regions of the liquid crystal display 120 having the ribs 150 formed therein protrude to a height T2 above the substrate surface. Gaps 182 are formed between the protruding ends of the ribs 150 and an opposite substrate 170. The ribs 150 have a function of shielding regions along the gate bus lines and a function of preventing any irregularity attributable to gravity. In order to set the gaps 182 at a predetermined value, the ribs 150 may have a structure in which a resist layer is further formed on the color resin layers.

FIG. 24 shows a sectional configuration of a region of the liquid crystal display 120 where a pillar spacer 160 is formed. The array substrate 121 has pillar spacers 160 which protrude from the substrate surface into the liquid crystal 180. The pillar spacers 160 of the liquid crystal display 120 protrude from the substrate surface into contact with the opposite substrate 170 in a compressed state.

A description will now be made with reference to FIGS. 18 to 24 on a method of manufacturing a liquid crystal display according to the present embodiment. In the present embodiment, a method of forming ribs on a COT type array substrate will be described. First, as shown in FIGS. 18 and 20, a metal layer is formed on a transparent substrate and patterned to form gate bus lines 122 and storage capacitor bus lines 126.

Next, a gate insulation film 131, an amorphous silicon (a-Si) film, and a silicon nitride film (SiN film) are continuously formed. Subsequently, in regions where TFT elements 124 are to be formed, the SiN film is patterned to form a channel protection film. Next, an n⁺ a-Si film and a metal layer are formed on the entire surface of the substrate. Then, the metal layer, the n⁺ a-Si film, and the a-Si film are patterned to form drain bus lines 123, drain electrodes, source electrodes, connection electrodes 128, storage capacitor electrodes 127, and active semiconductor layers (not shown). Thus, an island pattern constituted by the a-Si film and the channel protection films is formed in the region where TFT elements 124 are to be formed.

TFT elements 124 are formed in positions where the gate bus lines 122 and the drain bus lines 123 intersect through the steps described so far. Next, for example, a SiN film is then formed on the entire surface of the substrate to provide a protective film 132.

Next, color filter layers in three colors are sequentially formed on the array substrate 121. Specifically, as shown in FIGS. 18 and 19, such as a pigment dispersion type colored resin in red is then applied to and patterned on the entire surface of the substrate to form color filter layers 141R. In addition to red pixel regions, the color filter layers 141R are formed in regions above the gate bus lines 122 in order to shield the TFT elements 124 from light. Openings 129 are formed in parts of the color filter layers 141R located above the storage capacitor electrodes 127.

A pigment dispersion type colored resin in green is then applied to and patterned on the entire surface of the substrate to form color filter layers 141G. The color filter layers 141G are formed in regions above the gate bus lines 122 in addition to green pixel regions. Openings 129 are formed in parts of the color filter layers 141G located above the storage capacitor electrodes 127.

Next, a pigment dispersion type colored resin in blue is applied to and patterned on the entire surface of the substrate to form color filter layers 141B. The color filter layers 141B are formed in regions above the gate bus lines 122 in addition to blue pixel regions. Thus, layered resin portions 142 each having two of the color filter layers 141R, 141G, and 141B in an overlapping relationship are formed in the regions located above the gate bus lines 122. Openings 129 are formed in parts of the color filter layers 141B located above the storage capacitor electrodes 127.

At the step of forming the color filter layers 141, layers are formed above the gate bus lines 122 as follows. In a region where no rib is formed, a layered structure in two colors constituted by the color filter layers 141R and 141B is formed. At this time, a height difference of about 1.8 μm (T1 in FIG. 19) is formed by the layered portion to prevent any reflection from the bus line metal, whereby a function of shielding the TFT element from light can be provided. In a region where a rib is formed, a layered structure in three colors constituted by the color filter layers 141R, 141G and 141B is formed. At this time, a height difference of about 3.0 μm (T2 in FIG. 20) is formed by the layered portion.

As shown in FIG. 18, dry etching is performed to provide openings in the protective film, thereby forming contact holes. Next, a transparent conductive film such as an ITO is formed and patterned on the entire surface of the substrate to form a pixel electrode 125 at each pixel region. The pixel electrodes 125 are electrically connected to the storage capacitor electrodes 127 through the contact holes.

Next, a resin film is applied to and patterned on the pixel electrodes 125 throughout the substrate to form pillar spacers 160. At this time, the pillar spacers 160 are provided by forming a pattern as shown in FIG. 21 using a novolac resin type photo-resist. For example, a height difference of about 4.4 μm (T3 in FIG. 21) is formed by the layered portions. The pillar spacers 160 are disposed in a density of one per several pixels to several tens pixels and are formed such that they intersect the layered resin portions 122. An array substrate 121 having a COT structure as shown in FIG. 18 is completed through the above-described steps.

An alignment film is formed on an opposite substrate 170 which is provided by forming a common electrode made of an ITO on a transparent substrate, and an alignment film is also formed on the array substrate 121. Liquid crystal droplets are dispensed onto the array substrate 121 using the ODF method, and the array substrate 121 and the opposite substrate 170 having an opposite electrode formed on the transparent substrate are combined. Thus, a liquid crystal 180 is sealed between the substrates 121 and 170. Since the surface of the opposite substrate 170 is substantially flat, the protruding ends of the pillar spacers 160 contact the opposite substrate 170. Thereafter, a liquid crystal display is completed through a module step for mounting driver Ics or the like.

FIGS. 24 to 26 schematically show a sectional configuration of the completed liquid crystal display. The height difference T1 at the layered portions on the gate bus lines is 1.8 μm, and the protruding height (height difference) T2 of the ribs 150 is 3.0 μm. In the regions of the ribs 150, the ribs 150 form a very small gap between the opposite substrate and themselves. As a result, a structure is provided in which there is a high resistance to a movement of the liquid crystal and in which the possibility of an irregularity attributable to gravity is small.

As thus described, according to the present embodiment, any irregularity attributable to gravity can be prevented even in the liquid crystal display 120 having the array substrate 121 in a COT structure by forming the ribs 150. Further, the ribs 150 and the pillar spacers 160 can be formed by stacking the color filter layers 141. It is therefore possible to reduce the number of members and to thereby reduce the manufacturing cost.

While two of the color filter layers 141R, 141G, and 141B are stacked to form a layered resin portions 142 in the present embodiment, all of the color filter layers 141R, 141G, and 141B may be stacked to form a layered resin portion 142.

### Fifth Embodiment

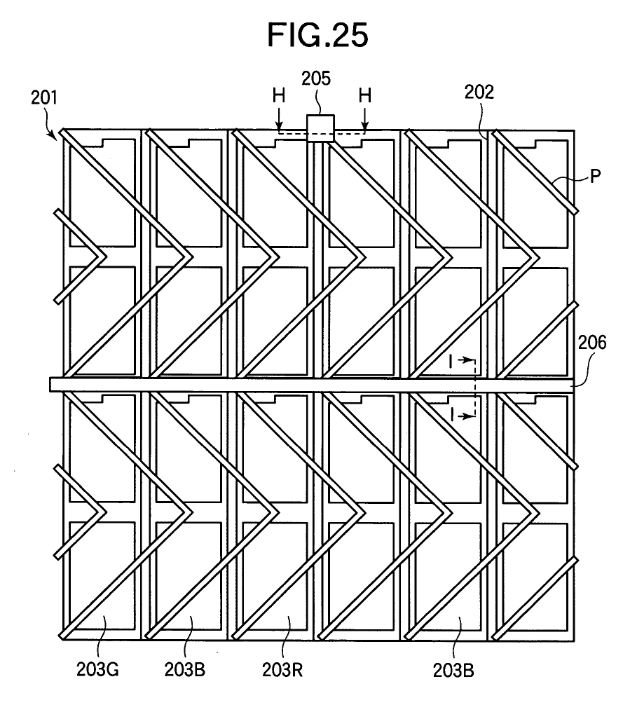

A fifth embodiment will now be described with reference to FIGS. 25 to 27. FIG. 25 shows an example of a plan configuration of an opposite substrate of a liquid crystal display according to the present embodiment. In the fourth embodiment described above, an example has been described in which color filter layers 141 are stacked on an array substrate 121 to form ribs 150 and pillar spacers 160. The present embodiment will show an example in which color filter layers 203 and a dielectric body for alignment regulation are stacked on an opposite substrate 201 to form pillar spacers 205 and in which ribs 206 are formed by the dielectric body for alignment regulation.

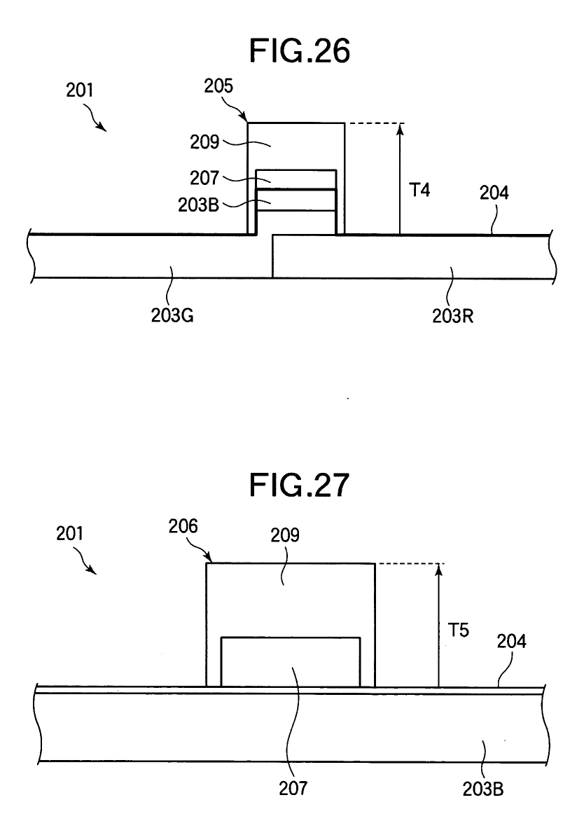

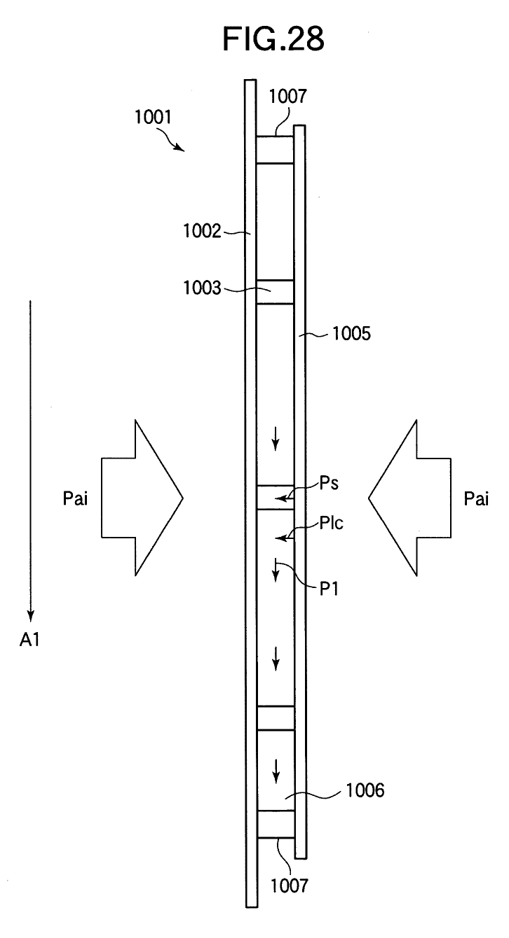

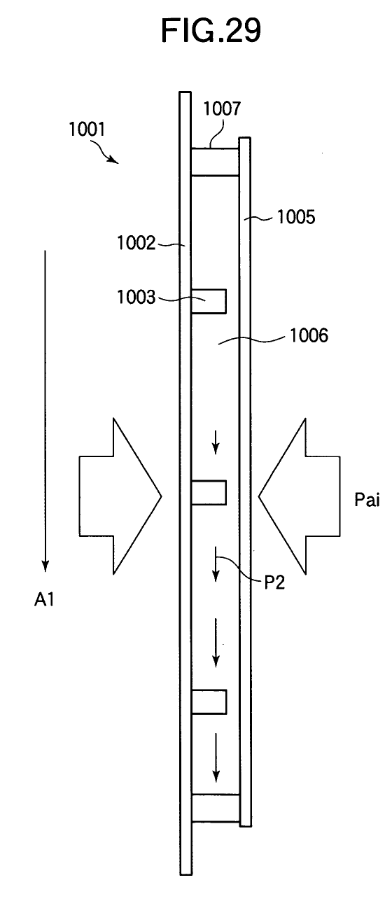

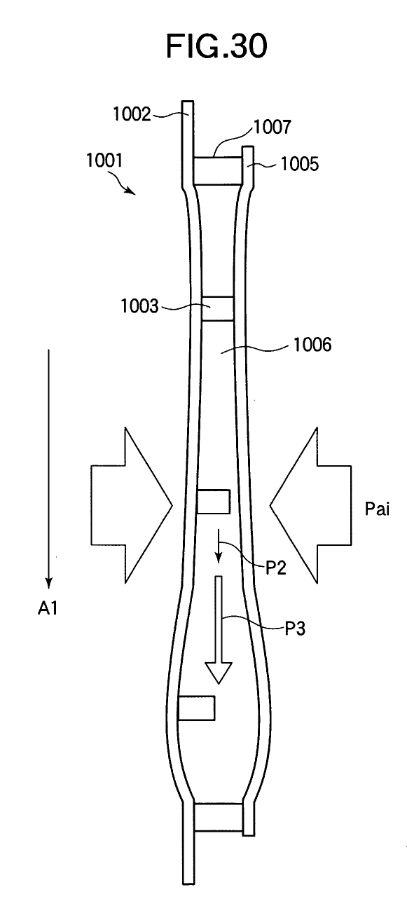

Specifically, on a transparent substrate constituting the opposite substrate 201 of the liquid crystal display, a black matrix 202 is formed, which is a shielding film for defining pixel regions and shielding storage capacitor portions from light, as shown in FIG. 25. A color filter layer 203 in any one of red (R), green (G), and blue (B) (203R, 203G, 203B) is formed in each of the pixel regions. In regions on the black matrix 202 where the pillar spacers 205 are to be formed, color filter layers 203R, 203G, and 203B in three colors are formed one over another. An opposite electrode 204 (see FIG. 26) constituted by a transparent conductive film is formed on the color filter layers 203 throughout the substrate. Linear alignment regulating protrusions P extending diagonally with respect to edges of the pixel regions are formed on the opposite substrate 204 as structures for regulating the alignment of the liquid crystal.

FIG. 26 shows a sectional configuration of the opposite substrate taken along the line H-H in FIG. 25. As shown in FIG. 26, the pillar spacers 205 are formed by stacking the color filter layers 203R, 203G, and 203B, the opposite electrode 204, and a material 207 for forming the alignment regulating protrusions, and a resist layer 209 in the order listed. For example, the resist layer 209 is formed from a resin material. The pillar spacers 205 are formed with a protruding height T4=3.8 μm, for example.

The top surfaces of the pillar spacers 205 contact the array substrate over a predetermined contact area when the opposite substrate is combined with the array substrate. A liquid crystal display having high anti-pressure characteristics can be provided by allowing the plurality of the pillar spacers 205 to contact the array substrate with a great total area of contact.

FIG. 27 shows a sectional configuration of the opposite substrate taken along the line I-I in FIG. 25. As shown in FIG. 27, in the regions where the ribs 206 are formed, the opposite electrode 204 is formed on the color filter layers 203B. The material 207 for the alignment regulating protrusions is formed on the opposite electrode 204. The resist layer 209 is formed on the material 207 for forming the alignment regulating protrusions. The ribs 206 are formed by stacking the material 207 for forming the alignment regulating protrusions and the resist layer 209.

A description will now be made on a manufacturing method according to the present embodiment in which the ribs are formed by stacking a dielectric body on the opposite substrate. First, a black matrix is formed on the transparent substrate using Cr, and R (red), G (green), and B (blue) layers are formed using respective pigment dispersion type colored resins. The film in each color is formed with a thickness of 1.8 μm, and color filter layers 203R, 203G, and 203B in a pattern as shown in FIG. 26 are stacked in a region where a pillar spacer is to be formed.

The opposite electrode constituted by an ITO is formed on the opposite substrate 201. Then, an alignment regulating protrusion P having a pattern as shown in FIG. 25 is formed with a thickness of, for example, 1.4 μm using a novolac resin resist. Further, the material 207 for forming the alignment regulating protrusion is also deposited on the region where a pillar spacer 205 is to be formed, and the material is formed in a pattern as shown in FIG. 25 in a region where a rib 206 is to be formed. Next, the novolac resin resist is applied to the regions where a pillar spacer 205 and a rib 206 are formed in a pattern as shown in FIG. 25, which completes the opposite substrate 201.

FIGS. 26 and 27 show sectional views of the regions of the opposite substrate 201 where the pillar spacer 205 and the rib 206 are formed. For example, the pillar spacer 205 is formed with a thickness of 3.8 μm, and the rib 206 is formed with a thickness of 3.0 μm. Alignment films are formed on the opposite substrate and the array substrate. A liquid crystal is sealed between the substrates using the ODF method, and polarizers are applied to complete a liquid crystal display.

The invention is not limited to the above-described embodiments, and various modifications may be made to the same.

For example, while transmissive liquid crystal displays have been referred to in the above-described embodiments, the invention is not limited to them and may be applied to other types of liquid crystal displays such as reflective and transflective types. Further, while liquid crystal displays having channel-protected TFT elements have been described in the above embodiments by way of example, the invention is not limited to them and may be applied to liquid crystal displays having channel-etched TFT elements. While liquid crystal displays having electrodes formed on opposite surfaces of a pair of substrates disposed in a face-to-face relationship have been described in the above embodiments by way of example, the invention is not limited to them and may be applied to IPS type liquid crystal displays in which electrodes are formed on only either of a pair of substrates facing each other.

1. a liquid crystal display comprising:
a pair of substrates opposite to each other;
a liquid crystal sealed between the pair of substrates;
a convex portion protruding into the liquid crystal from a surface of at least either of the pair of substrates and extending in a substantially horizontal direction when the pair of substrates is erected in the vertical direction; and a gap formed between the protruding end of the convex portion and a surface of the other substrate.

2. A liquid crystal display according to claim 1, wherein the gap has a width d which satisfies 0.2 μm≦d≦2 μm.

3. A liquid crystal display according to claim 1 or 2, wherein a plurality of the convex portions Is displosed in the vertical direction.

4. A liquid crystal display according to claim 3, wherein a plurality of the convex portions is disposed in the vertical direction at intervals constituted by a plurality of pixels.

5. A liquid cyystal display according to claim 1 or 2, wherein both ends of the convex portion extend to a light shield portion provided around a display area.

6. A liquid crystal display according to claim 5, wherein the both ends of the convex portion are in contact with a seal material formed like a frame outside the display area.

7. A liquid crystal display according to claim 1 or 2, wherein the convex portion is formed on a bus line formed on a surface of one of the substrates.

8. A liquid crystal display according to claim 1 or 2, wherein the convex portion is formed in a position facing a bus line formed on a surface of the other substrate.

9. A liquid crystal display according to claim 1 or 2, wherein the convex portion is formed on a light shield film formed on the surface of the one of the substrates.

10. A liquid crystal display according to claim 1 or 2, wherein the convex portion is formed in a position facing a light shield film formed on the surface of the other substrate.

11. A liquid crystal display according to claim 1 or 2, wherein the convex portion protrudes from the bottom of a recess formed on the surface of the one of the substrates.

12. A liquid crystal display according to claim 1 or 2, wherein the convex portion is formed from a dielectric material.

13. A liquid crystal display according to claim 12, wherein the dielectric material is a resin material.

14. A liquid crystal display according to claim 12, wherein the convex portion is formed in the same layer as a pillar spacer provided between the substrates to maintain a cell gap and is formed from the same material as the spacer.

15. A liquid crystal display according to claim 12, wherein the convex portion has color resin layer.

16. A liquid crystal display according to claim 15, wherein the color resin layer comprises color resin layers in a plurality of colors formed one over another.

17. A liquid crystal display according to claim 15, wherein the convex portion ha s resist layer formed on the color resin layer.

18. A liquid crystal display according to claim 12, wherein the convex portion has a structure in which a resist layer is formed on a dielectric layer located in the same layer as an alignment regulating structure for regulating the alignment of the liquid crystal.
